(19) United States
(12) Patent Application Publication
(10) Pub. No.: US 2006/0139000 A1
(43) Pub. Date: Jun. 29, 2006

(54) Wrist worn portable battery charging system

(76) Inventors: Kenneth Stephen Bailey, Newport Beach, CA (US); Fernando Barrera JR., Ontario, CA (US); Fernando Alberto Barrera, West Hills, CA (US)

Correspondence Address: KENNETH S. BAILEY, 2149 VISTA DORADO STREET, NEWPORT BEACH, CA, 92660, US

(21) Appl. No.: 11/318,771

(22) Filed: Dec. 27, 2005

Related U.S. Application Data
(60) Provisional application No. 60/640,401, filed on Dec. 29, 2004.

(51) Int. Cl. H02J 7/00

(52) U.S. Cl. 320/114

(57) ABSTRACT

A wrist worn battery charging system is disclosed which may be utilized to power or charge the batteries of portable devices, such as wrist worn PDA's, wrist worn Cell-Phones, wrist worn PC's, wrist worn walkie-talkies, wrist worn MP3 players, or other electronic devices which are battery powered and worn on the body of the user. The battery charger operates by turning the motion of the user's arm into electrical energy by the action of a miniature D.C. generator. The output voltage may be used to trickle charge a battery, or supply energy necessary to sustain power for the operation of a number of portable devices. The system is sealed and encapsulated to prolong its' useful life and disguise its' appearance.

This application claims priority to U.S. provisional application Ser. No. 60/640,401, filed Dec. 29, 2004, the disclosure of which is incorporated by reference.

### BACKGROUND OF THE INVENTION

For many years the use of battery chargers and systems to sustain battery life have evolved. We are reminded by the popular motion picture regarding the historic space flight of Apollo 13, that non-volatile memory was not invented until the early 70's with the creation of the a multi-layered capacitor deposited on the dye wafer substrate by sputtering techniques. Much earlier, automobile batteries were first charged by D.C. generators and later on by Alternators. More recently we have evolved solar panels as light driven energy sources, and most recently a group known as Tiny Battery Technologies of Israel has developed “Power Paper”, which is a battery derived from printing utilizing special ink on opposite sides of a sheet of standard paper, to create a paper thin battery.

The advent of the cellular telephone, followed by the Personal Digital Assistant (PDA), and more recently the Game Boy portable gaming device has helped to promote the rapid development of rechargeable battery sources and more sophisticated battery designs. Rapid miniaturization of PC's and Hand-Held cellular telephones has necessitated the miniaturization of batteries and other power sources as well. Understandably, a portable device must be able to be utilized for extended periods of time without the need for recharging, or the device becomes worthless, or useless, as the utilization period becomes limited.

As mentioned above, earlier devices relied upon solar cells to trickle charge the portable device's internal battery. Now, with ever increasing power needs, such as portable PC's, digital cameras, and cellular phones with color displays, the power consumption of the hardware became a serious concern, in terms of battery life and longevity of usage. These modern device's needs could not be satisfied by mere trickle charging with a solar panel, since the size of the solar panel would be prohibitive in these applications. Many a traveler or tourist has resorted to carrying numerous spare batteries to compensate for limited battery life or the need for protracted portable usage of a device. In remote locations or while traveling in most forms of public transportation, plug-in power points are not readily available, for recharging portable devices. Soon the miniaturization of cell phones, PDA's, PC's and other portable devices will result in wrist worn phones, PDA's and PC's which will require battery power, and will necessitate a solution for charging the unit's internal battery, when no possible way of charging is available. Examples, such as while traveling in an aircraft, a train, a bus, or other form of public transportation vehicle, come to mind. The current invention satisfies this need in a wrist worn battery charger.

Anyone, who has ever owned a portable computer, hand-held cellular phone or PDA, knows the frustration of having the battery give out during an important phone call, presentation or IP session. In fact the invention disclosed herein could also be used as a temporary solution for anyone, who needs that last little bit of power to complete the call, finish the email or retrieve a message. As an after market plug in attachment, the present invention solves the need for temporary emergency power, while the user is away from a plug-in charging source, such as an AC outlet or vehicle cigarette lighter plug or a spare battery.

As an after market device, the present invention could be carried in the user's pocket and either attached by Velcro to the back of the cellular phone and connected through the external charging point, or plugged into the power point of a laptop or PDA. The charger would be activated, by shaking the module described herein, to generate enough trickle charge energy to energize the device's battery for just long enough to complete the call or IP session or the like. The charger described herein could be used to energize any power source or any portable or hand-held device on a short-term basis, including portable gaming devices.

### BRIEF DESCRIPTION OF THE DRAWINGS

FIG. 1. The present invention consists of (1) a permanent magnet, (2) a series of copper coils, interconnected to act in unison, (3) an interface circuit to connect from the charger to the battery being charged or energized.

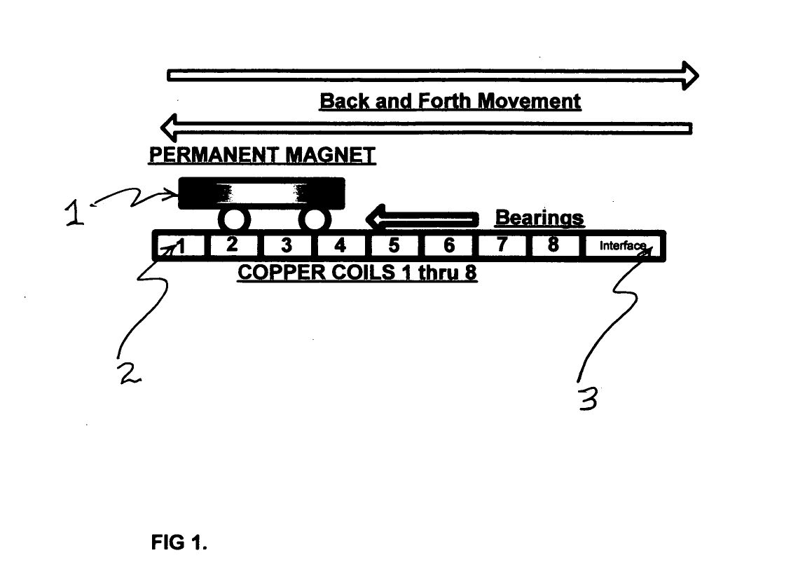

FIG. 2. The permanent magnet (1) is made to slide from end to end by riding on a series of ball bearings (4) seated in a track (5) beneath the permanent magnet. The magnet thus passes back and forth or to and fro over the series of copper coils (2), creating electrical energy in each of the copper coils as it passes over them. This energy is stored in a charged capacitor (6) until the capacitor is charged to its' threshold at which time the energy is converted to an DC current by a pair of diodes (7), (8) whose output is directed to the battery.

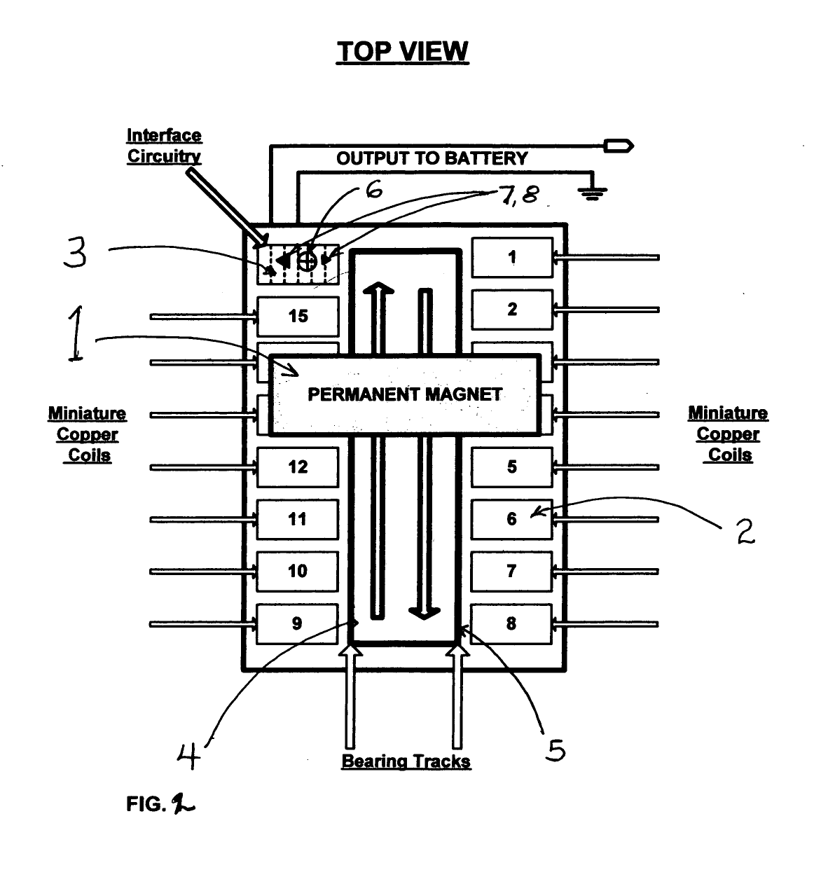

FIG. 3. Depicts the charger (10) attached to the user's arm at the wrist (12) and the wrist action (13) in charging the battery with the battery charger.

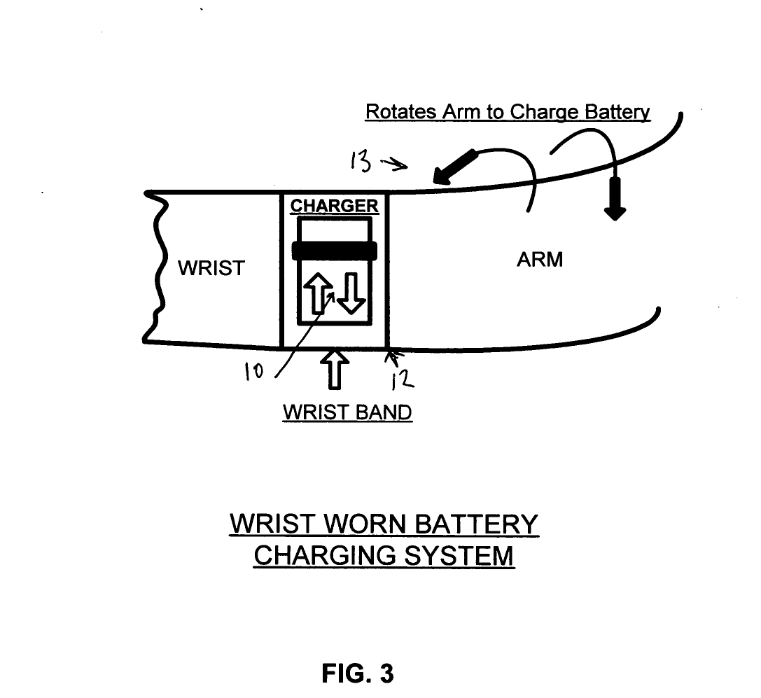

FIG. 4. Depicts the ad-hoc portable attached plug-in charger configuration (14) having been attached to the back of the hand-held mobile phone (15) with Velcro such that the user, can shake the phone for a few seconds to create energy such that the charger then trickle charges the battery.

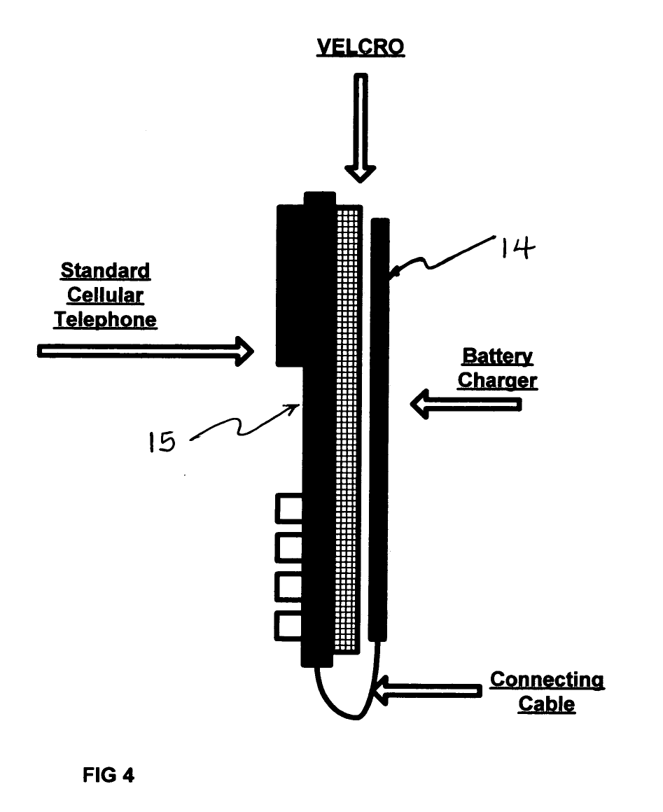

FIG. 5. Depicts the charger (10) attached to a laptop computer (16) and the user's charging action by shaking the charger up and down while charging the laptop's internal battery (17).

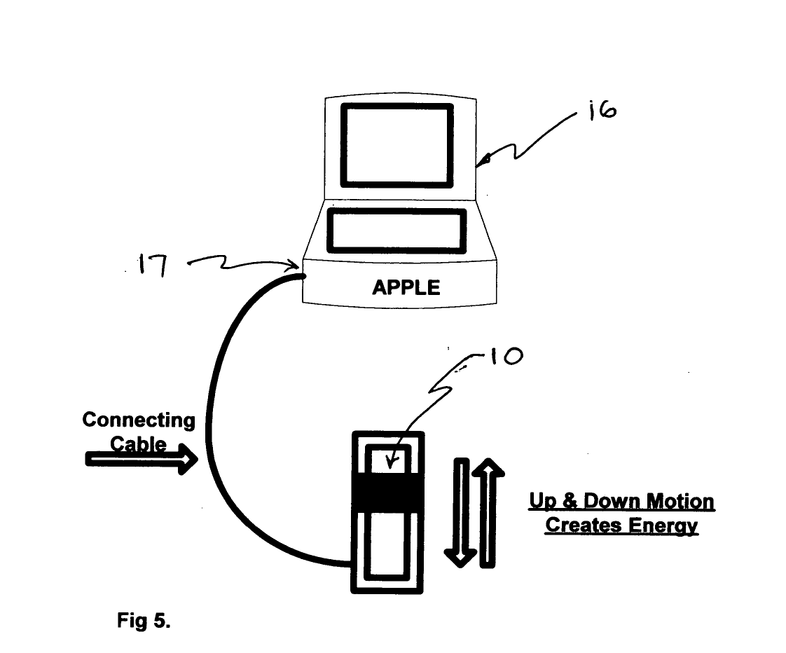

FIG. 6. Depicts the charger (10) being carried in the user's pants pocket (18) and attached to the user's portable cellular phone (19) while being worn on the user's hip. The action or motion of the user's leg (20) creates energy while the user is walking in order to charge the portable phone (19) as the user walks or jogs about.

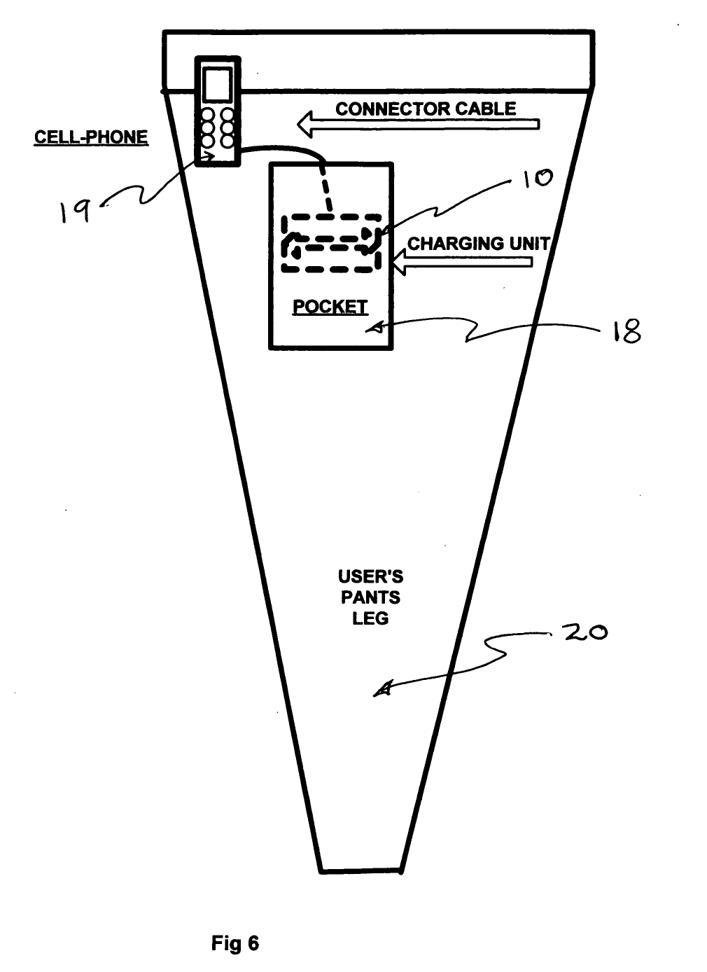

FIG. 7. Depicts a schematic diagram of the interface circuitry.

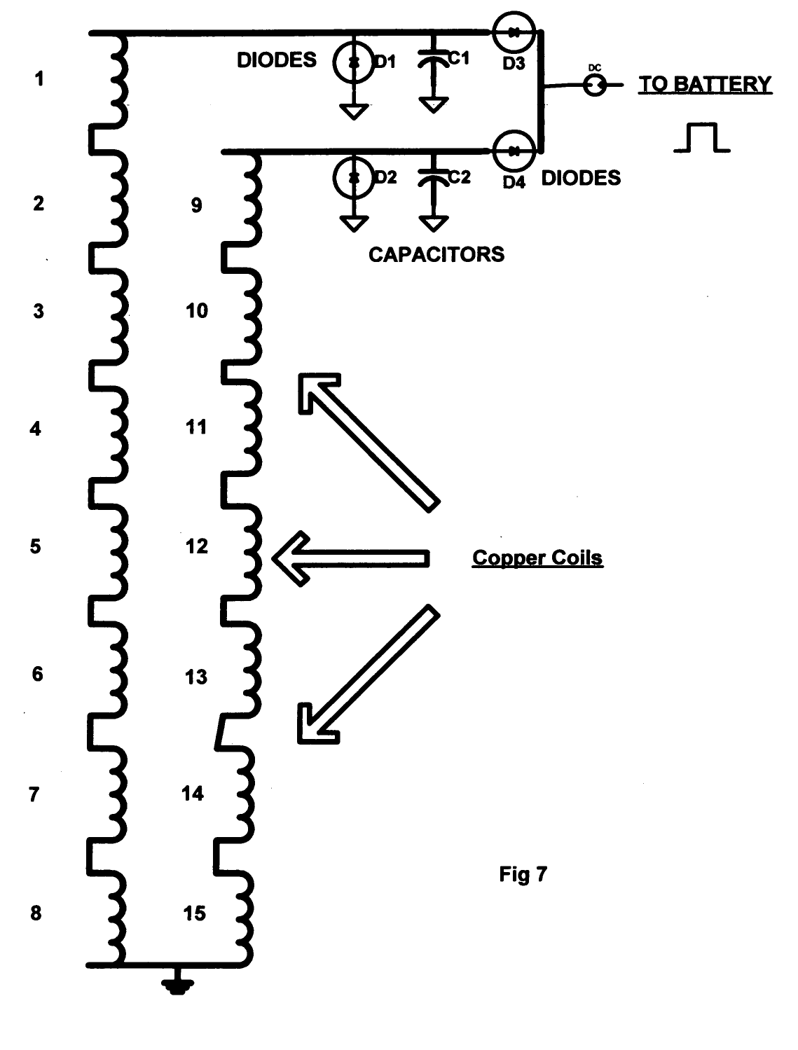

What is claimed is:

1. A portable battery charging system, for the charging of portable batteries as might be utilized in cellular telephones, Personal Digital Assistants (PDA's), laptop computers, portable gaming devices, and various other forms of communications equipment, where the charging system is worn on the body of the user comprising:
A permanent magnet mounted on a sled, riding back and forth on two rails, surrounded by a linear array of copper coils on both sides; and
The above coils attached to an electronic circuitry consisting of a battery interface of diodes and capacitors for filtering of the output pulses; and
The entire system is encapsulated in a sealed container which is filled with a lubricating liquid, such as light weight synthetic oil; and
The system has a connecting cable that can be plugged into the charging point of the portable device whose battery is being charged.

2. The system described in claim 1, where the sealed container is attached to a strap that can be wrist worn by the user.

3. The system described in claim 1, wherein the sealed container can be carried in the users pocket and attached to a portable device under charge while the user is walking or jogging.

4. The system described in claim 1, where the sealed container is attached to velcro and can be affixed to the back of a portable communications device, such as a cellular telephone or PDA device, and the device's battery may be charged by the user's movement, or the sealed container may be shaken by the user to hasten the charging process.

5. The system described in claim 1, where the sealed container may be permanently affixed, attached or internally installed and designed into a cellular telephone, PDA, laptop or other communication device, by which, charging of the device's internal battery may occur at any time the communications device or laptop computer is moved, shaken or oscillated back and forth.
